(19) United States
(12) Patent Application Publication
(10) Pub. No.: US 2019/0378215 A1
(43) Pub. Date: Dec. 12, 2019

(54) IMPLEMENTING MORATORIUMS IN REAL-TIME USING AUTOMATED SERVICES WITH A CUSTOMIZED DATABASE

(71) Applicant: Hippo Analytics Inc. dba Hippo Insurance Services, Mountain View, CA (US)

(72) Inventors: Arie Yelovitch, Santa Clara, CA (US); Michael P. Gulla, Cupertino, CA (US); Adrian Mihai Olariu, Tg Mures (RO)

(21) Appl. No.: 16/003,898

(22) Filed: Jun. 8, 2018

(51) Int. Cl. G06Q 40/08; G06F 17/30

(52) U.S. Cl. CPC G06Q 40/08; G06F 17/30002

(57) ABSTRACT

An insurance policy architecture implements a database using a data interchange format for storing binding restriction or moratorium information. The insurance policy architecture is communicatively coupled to one or more servers that provide the binding restriction or moratorium information. The servers include government agency servers and insurance underwriter servers. The binding restriction or moratorium information may be provided using a push-based model or a pull-based model. The database is implemented as a single file, where the single file comprises a definition for a multi-dimensional array. Each level of the multi-dimensional array corresponds to a different characteristic of the binding restriction or moratorium. The most granular level of the multi-dimensional array defines various attributes having one or more attribute values that define a particular binding restriction or moratorium.

### TECHNICAL FIELD

The subject matter disclosed herein generally relates to the technical field of database management and design and, in particular, to implementing a database that can be readily populated and queried with minimal impact to computing performance and resources.

### BACKGROUND

In managing the issuance and cancellations of insurance policies for an insurance agency, there are generally two considerations. With regard to the issuance of new insurance policies, the insurance agency is often required to confirm whether a state licensing agency or state insurance regulatory authority has issued any binding restrictions on the issuance of such policies. In many circumstances, this can be a laborious process, usually requiring an insurance agent to manually confirm whether such restrictions exist and/or to refer to physical documents to determine whether such restrictions exist.

With regard to cancellations, the insurance agency is often required to confirm whether a state licensing authority or state regulatory authority has issued any moratoriums on the cancellation of such policies. Under some conditions, such as natural disasters, the state licensing authority or state regulatory authority may issue moratoriums that prohibit an insurance agency or underwriter from cancelling policies held by consumers. Because the insurance platform of a typical insurance agency and/or underwriting does not electronically communicate directly with the licensing authority or regulatory authority, a person (e.g., an insurance agent) is typically involved in the manual entry and/or confirmation of these moratoriums. This manual entry can present a host of problems for the insurance agency and/or underwriting including, but not limited to, inaccurate entries, inconsistent entries, untimely entries, and other such problems that typically come along with the manual of entry of data.

### BRIEF DESCRIPTION OF THE DRAWINGS

Some embodiments are illustrated by way of example and not limitation in the figures of the accompanying drawings.

FIG. 1 is a block diagram illustrating a networked system, according to some example embodiments, including a policy issuance architecture.

FIG. 2 illustrates various components of the policy issuance architecture of FIG. 1, according to an example embodiment.

FIG. 3 illustrates a processing diagram, in accordance with an example embodiment, of the various components illustrated in FIG. 2 that implement that the disclosed policy issuance architecture.

FIGS. 4-5 illustrate various graphical user interfaces, according to example embodiments, for manipulating one or more binding restrictions and/or moratoriums maintained by the policy issuance architecture shown in FIG. 2.

FIG. 6 illustrates a method, in accordance with an example embodiment, for obtaining binding restriction and/or moratorium data from a government agency server as shown in FIG. 1.

FIG. 7 illustrates a method, in accordance with an example embodiment, for obtaining binding restriction and/or moratorium data from an insurance underwriter server as shown in FIG. 1.

FIGS. 8A-8B illustrate method, in accordance with an example embodiment, for evaluating one or more binding restrictions and/or moratoriums using user-provided information.

FIG. 9 is a block diagram illustrating components of a machine, according to some example embodiments, able to read instructions from a machine-readable medium (e.g., a machine-readable storage medium or machine-readable storage device) and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

This disclosure provides for an insurance policy issuance architecture that integrates and communicates with one or more government agency servers and/or insurance underwriter servers for managing binding restrictions and/or moratoriums for one or more insurance policies offered by an insurance agency. In this regard, a binding restriction is generally considered one or more restrictions on the issuance of an insurance policy. The binding restrictions may include one or more limitations on the coverage that an insurance agency can issue under the policy (e.g., policy limits, damage coverage, limits on natural disaster coverage, etc.), but it may also cover whether the insurance agency can offer an insurance policy at all. In general, binding restrictions are typically issued where a geographic area (e.g., a particular ZIP code and/or neighborhood) is affected by a natural disaster (e.g., a fire, tornado, hurricane, etc.). With regard to a moratorium, this is an alert that notifies an insurance agency whether an insurance policy, generally for a particular geographic region, can be cancelled. In a typical scenario, an insurance underwriter and/or government agency may issue a moratorium on the cancellation of insurance policies during natural disasters. A moratorium is often issued to prevent an insurance agency from cancelling an insurance policy when the underwriter would be liable for expected damage (e.g., a known hurricane is approaching a geographic area).

One of the technical challenges with the notification of binding restrictions and moratoriums is that an insurance agency may be slow to adapt and/or integrate the binding restriction and/or moratorium into the insurance agency's policy insurance system. Thus, there are instances where the insurance agency inadvertently issues policies when a binding restriction applies or cancels policies where a moratorium is in effect. Accordingly, the disclosed update services and data integrators allows the disclosed policy issuance architecture to integrate issued binding restrictions and moratoriums on a near real-time basis so that the insurance agency can apply the binding restrictions and/or moratoriums within a short time window soon as the binding restrictions and/or moratoriums are issued.

In one embodiment, the insurance policy issuance architecture implements one or more communication services and/or adapters that are configured to ingest and/or retrieve notifications sent or communicated by a government agency and/or an insurance underwriter. Using various data processing technologies, such as natural language processing, string matching, regular expression matching, optical character recognition, and other such data processing technologies, the insurance policy issuance architecture is configured to integrate binding restriction and/or moratorium particulars into a non-traditional database configured to store such information. These adapters and services provide a technical benefit to the overall architecture because they enable the insurance agency to obtain and/or integrate the binding restriction and/or moratorium details without human intervention or review. This feature leads to increased accuracy and data consistency for newly issued binding restrictions or moratoriums, and ensures that insurance policies are not inadvertently issued or cancelled. Such advancements are beneficial to both the insurance agency and the policy holder—for the insurance agency, these advancements ensure that the agency does not take on additional risk that the underwriter is unwilling to guarantee; for the policy holder, it ensures that the policy being held by the policy holder is not inadvertently cancelled and becomes primarily liable for any losses that the holder may incur.

The insurance policy issuance architecture also employs a non-traditional database to store and/or manage the binding restrictions and moratoriums issued by the licensing agency or insurance underwriter. In this regard, the database is considered non-traditional in that it may not conform to a typical implementation of a relational or two-dimensional database. For example, databases implemented using the Standard Query Language (“SQL”) are implemented using a main database file that may include one or more pages, where the size of a given page is a power of two between 512 and 65536 inclusive. When implemented in this fashion, the pages within the same database file are generally same size.

One of the challenges with a database implemented in a traditional SQL format is that the time for lookups in the database can increase exponentially with the amount of data being stored in the database. In the case with insurance policies, each binding restriction and/or moratorium includes several attributes, where each attribute includes multiple values. Although each binding restriction and/or moratorium may be small in size relative to the amount of storage space available, the number of values associated with each binding restriction and/or moratorium is non-trivial. Thus, the number of rows, columns, and/or cells within the database may increase rapidly with the addition of each binding restriction and/or moratorium. This factor can present a technical challenge to quickly issuing insurance policies and/or determining whether to cancel an insurance policy (e.g., for lack of payment) as the time for lookups and searches within the database increases with the addition of each binding restriction and/or moratorium. Furthermore, as the database expands to cover additional geographic areas (e.g., cities, states, neighborhoods, etc.), the database can become increasingly difficult to manage and require further technologies and/or implementations to properly manage it. Thus, the disclosed implementation of the described database represents a technical advance over prior implementations as it requires less time for database lookups, searches, additions, deletions, etc., and requires less supporting technologies to manage. In the era of digital communications, a company being able to perform a certain task in less time than its competitors is both a technical advantage and a financial one.

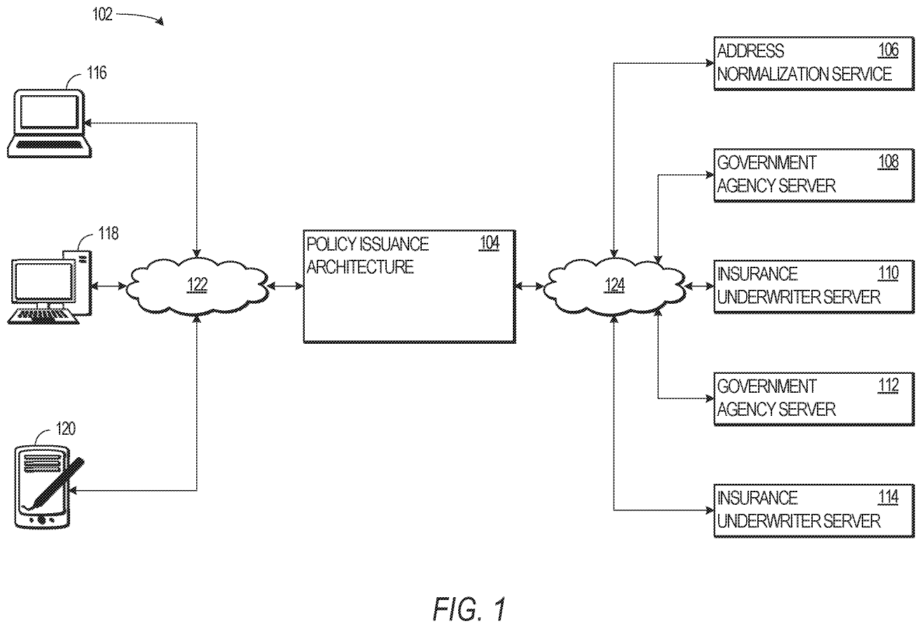

This disclosure now turns to the various disclosed embodiments that implement the technical aspects disclosed herein. With reference to FIG. 1, an example embodiment of a high-level client-server-based network architecture 102 is shown. A policy issuance architecture provides server-side functionality via a network 122 (e.g., the Internet or wide area network (WAN)) to one or more client devices 116-120. A client device, such as client device 116, may include different applications and/or modules for interacting with the policy issuance architecture 104. Examples of application that may be instantiated by the client device 116 include a web client, a single-purpose application (e.g., an “app”), a multi-purpose application (e.g., a programmatic client), or combinations thereof. The policy issuance architecture 104 is further communicatively coupled with other client devices 118-120, which may include similar applications and/or programs as the client device 116.

The client device 116 may comprise, but is not limited to, a mobile phone, desktop computer, laptop, portable digital assistant (PDA), smart phone, tablet, ultra book, netbook, laptop, multi-processor system, microprocessor-based or programmable consumer electronic, or any other communication device that a user may utilize to access the policy issuance architecture 104. In some embodiments, the client device 116 may comprise a display module (not shown) to display information (e.g., in the form of user interfaces). In further embodiments, the client device 116 may comprise one or more of touch screens, accelerometers, gyroscopes, cameras, microphones, global positioning system (GPS) devices, and so forth. The client device 116 may be a device of a user that is used to perform various interactions with the policy issuance architecture 104, such as for requesting an insurance policy quote, updating payment information, reviewing insurance policy documents, and other such interactions.

In one embodiment, the policy issuance architecture 104 is a network-based appliance that communicates notifications to the client devices 118-120, where one or more of the notifications indicate the interactions and/or activities performed by other members of the online service. One or more users may be a person, a machine, or other means of interacting with the client device 116. In various embodiments, the user is not part of the network architecture 102, but may interact with the network architecture 102 via the client device 116 or another means. For example, one or more portions of the networks 122-124 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 116 may include one or more applications (also referred to as “apps”) such as, but not limited to, a web browser, messaging application, electronic mail (email) application, a dedicated insurance policy platform application, and the like. In some embodiments, if the insurance policy application is included in the client device 116, then this application is configured to locally provide the user interface and at least some of the functionalities with the application configured to communicate with the policy issuance architecture 104, on an as needed basis, for data and/or processing capabilities not locally available (e.g., access to a policy holder profile and/or policy information, to authenticate a user, to retrieve and/or display insurance policy documents, etc.). Conversely if the social networking access client is not included in the client device 116, the client device 116 may use its web browser to access the services provided by the policy issuance architecture 104.

The user may interact with the network architecture 102 via the client device 116 or other means. For instance, the user provides input (e.g., touch screen input or alphanumeric input) to the client device 116 and the input is communicated to the client-server-based network architecture 102 via the network 122. In this instance, the policy issuance architecture 104, in response to receiving the input from the user, communicates information to the client device 116 via the network 122 to be presented to the user. In this way, the user can interact with the policy issuance architecture 104 using the client device 116.

Further, while the client-server-based network architecture 102 shown in FIG. 1 employs a client-server architecture, the present subject matter is of course not limited to such an architecture, and could equally well find application in a distributed, or peer-to-peer, architecture system, for example.

In addition to the client devices 116-120, the policy issuance architecture 104 communicates with various different types of servers and/or services 106-114. In one embodiment, the additional servers and/or services 106-114 includes an address normalization service 106, one or more government agency servers 108,112 and one more insurance underwriter servers 110,114. The policy issuance architecture 104 may be configured to communicate with the one or more services and/or servers 106-114 via a network 124. Like network 122, the network 124 may be a combination of intranets, Wide Area Networks, ad-hoc networks, the Internet. and other such networks.

Each of the services and/or servers 106-114 may provide an application programming interface (“API”) or other means for accessing the information and/or services provided by the corresponding organization, agency, and/or underwriter. With regard to the address normalization service 106, this service may provide the policy issuance architecture 104 with a normalized address when given a partial and/or complete address. The policy issuance architecture 104 may then use the normalized address to determine whether any of the binding restrictions and/or issued moratoriums apply before issuing and/or cancelling an insurance policy.

The government agency servers 108,112 may correspond to various governmental entities where the policy issuance architecture 104 is authorized to operate. For example, the government agency server 108 may correspond to an insurance regulatory authority in California and the government agency server 112 may correspond to an insurance regulatory authority in Illinois. Additional states and/or other types of government agencies are also contemplated as falling within the scope of this disclosure.

The insurance underwriter servers 110,114 may correspond to insurance underwriters that support the insurance agency that operates the policy issuance architecture 104. In one embodiment, each insurance underwriter contracted with the insurance agency establishes an insurance underwriter server 110, 114 that provides various types of insurance-related information to the policy issuance architecture 104, including information relating to or about the binding restrictions and/or moratoriums. In some instances, the insurance underwriters may issue their own binding restrictions and/or moratoriums, in which case, the policy issuance architecture 104 is configured to obtain such information form these servers 110,114. Additionally and/or alternatively, a government agency may prohibit and/or limit access to their own servers, in which case, the policy issuance architecture 104 may leverage the access to the insurance underwriter servers 110,114 to obtain the binding restrictions and/or moratorium information.

The servers 108-114 may operate on a push-based and/or subscription-based model. In a push-based model, the servers 108-114 send an electronic communication to the policy issuance architecture 104 notifying the policy issuance architecture 104 that an update to a binding restriction and/or moratorium is available along with the information associated with the update. In this instance, an update may mean a new binding restriction and/or moratorium, a change in an existing binding restriction and/or moratorium, or the termination/deletion of an existing binding restriction and/or moratorium. Examples of push-based models include, but are not limited to, streaming via the HyperText Markup Protocol (HTTP), persistent HTTP connections, the use of the Simple Mail Transfer Protocol (“SMTP”) in conjunction with Post Office Protocol Version 3 (“POP3”) or Internet Message Access Protocol (“IMAP”), the services available under the Extensible Messaging and Presence Protocol (“XMPP”), one or more WebHooks, and other such push-based models or combinations thereof.

Additionally and/or alternatively, the servers 108-114 may operate on a pull-based model for delivering updates on one or more binding restrictions and/or moratoriums. In general, a pull-based model is a system where a client (e.g., the policy issuance architecture 104) queries a provider (e.g., the servers 108-114) whether certain types of information are available or whether there are updates to information that the client expects to be available. Under this regime, the policy issuance architecture 104 may implement a pull-based model to determine whether there are any updates to one or more binding restrictions and/or moratoriums issued by the government agencies and/or insurance underwriters associated with the servers 108-114. In implementing the pull-based model, the policy issuance architecture 104 may request updates from the various servers 108-114 at predetermined time intervals (e.g., every 15 minutes) and/or on a predetermined schedule (e.g., once a day). In some instances, the policy issuance architecture 104 may implement both a push-based model and a pull-based model for one or more of the servers 108-114 that are in communication with the policy issuance architecture 104.

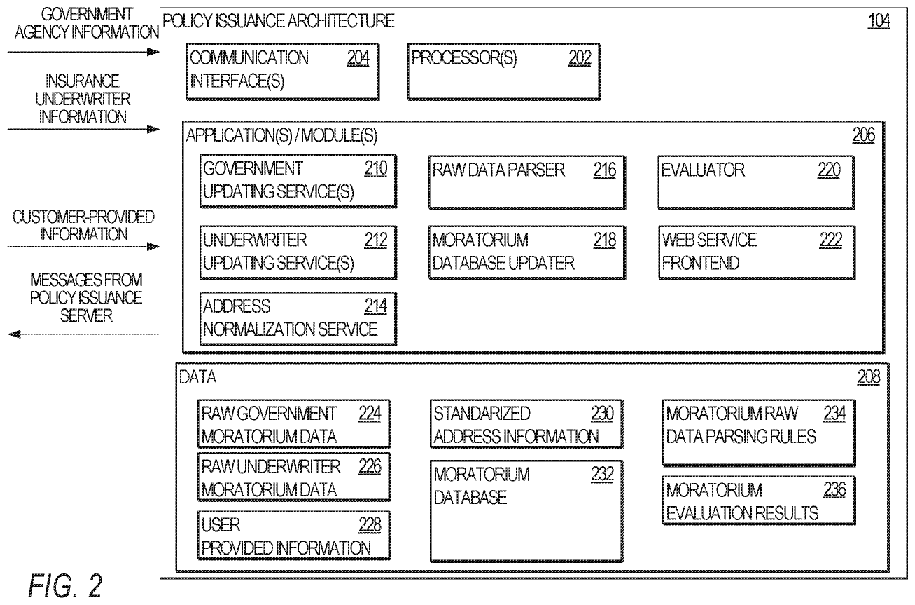

FIG. 2 illustrates various components of the policy issuance architecture 104 of FIG. 1, according to an example embodiment. In one embodiment, the policy issuance architecture 104 includes various application(s) and/or modules(s) 206 to facilitate the real-time integration of one or more binding restrictions and/or moratoriums and data 208 used to support one or more functionalities of the application(s) and/or module(s) 206. Although not shown in detail, the policy issuance architecture 104 may also include hardware and/or software components typically implemented in one or more computing devices, such as one or more hardware processors, one or more computer-readable media, one or more communication interfaces, one or more input and/or output devices, and other such components found in a computing device.

The various functional components of the policy issuance architecture 104 may reside on a single device or may be distributed across several computers in various arrangements. The various components of the policy issuance architecture 104 may, furthermore, access one or more databases (e.g., the moratorium database 232), and each of the various components of the policy issuance architecture 104 may be in communication with one another. Further, while the components of FIG. 2 are discussed in the singular sense, it will be appreciated that in other embodiments multiple instances of the components may be employed.

The policy issuance architecture 104 may include one or more processor(s) 202 configured to execute one or more computer-executable instructions for instantiating the various application(s)/module(s) 206. The processor(s) 202 of the policy issuance architecture 104 may be any type of commercially available processor, such as processors available from the Intel Corporation, Advanced Micro Devices, Texas Instruments, or other such processors. Further still, the one or more processors may include one or more special-purpose processors, such as a Field-Programmable Gate Array (FPGA) or an Application Specific Integrated Circuit (ASIC). The processor(s) 202 may also include programmable logic or circuitry that is temporarily configured by software to perform certain operations. Thus, once configured by such software, the processor(s) 202 become specific machines (or specific components of a machine) uniquely tailored to perform the configured functions and are no longer general-purpose processors.

The policy issuance architecture 104 also include one or more communication interface(s) 204 for establishing one or more communication channels with various devices, servers, and equipment. In one embodiment, the policy issuance architecture 104 uses the communication interface(s) 104 to establish communication channels with the client devices 116-120, the address normalization service 106, and the various government and underwriter servers 108-114. The communication interface(s) 104 may include one or more wired and/or wireless communication interfaces such as IEEE 802.3, IEEE 802.11, Bluetooth, or any other wired and/or wireless communication interface now known or later developed. The policy issuance architecture 104 may also use the communication interface(s) 204 to facilitate human/machine interactions using one or more input and/or output devices such as a keyboard, mouse, microphone, speakers, displays (touchscreen or otherwise), and other such input and/or output devices. Examples of communication interface(s) 204 used by the policy issuance architecture 104 for input and/or output devices, include, but are not limited to PS/2, Universal Serial Bus (“USB”), High-Definition Multimedia Interface (“HDMI”), Thunderbolt, or any other communication interface used for human/machine interactions now known or later developed.

Using various machine-readable media, the policy issuance architecture 104 implements the application(s) and/or module(s) 206 and stores the data 208. The machine-readable media may include one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable media” should be taken to include a single medium or multiple media (e.g., a centralized or distributed database, or associated caches and servers) able to store the application(s) and/or module(s) 206 and the data 208. The term “machine-readable media” may also include one or more machine-readable storage devices. Accordingly, the machine-readable medium may be implemented as a single storage apparatus or device, or, alternatively and/or additionally, as “cloud-based” storage systems or storage networks that include multiple storage apparatus or devices.

In one embodiment, the application(s) and/or module(s) 206 are written in a computer-programming and/or scripting language. Examples of such languages include, but are not limited to C, C++, C#. Java. JavaScript, Perl, Python, or any other computer programming and/or scripting language now known or later developed. In this manner, each of the application(s) and/or module(s) 206 may be implemented in one or more computer-programming and/or scripting language.

With reference to FIG. 2, the application(s) and/or module(s) 206 of the policy issuance architecture 104 are configured to obtain and integrate binding restrictions and/or moratoriums issued by government agencies and/or insurance underwriters in real-time or near real-time. To perform these and other operations, the application(s) and/or module(s) 206 include, but are not limited to, one or more government updating service(s) 210, one or more underwriting updating service(s) 212, an address normalization service (214), and a raw data parser 216. The application(s) and/or module(s) 206 further include a moratorium database updater 218, an evaluator 220, and a web-service frontend 222. While the policy issuance architecture 104 may include alternative and/or additional applications (e.g., a web-hosting platform, a networking application, a printing application, a software-implemented keyboard, etc.), such alternative and/or additional applications are not germane to this disclosure and the discussion of such is hereby omitted for brevity and readability.

The data 208 referenced and used by the application(s) and/or module(s) 206 include various types of data in support of integrating the discussed binding restrictions and/or moratoriums, and determining whether to issue and/or cancel insurance policies according to the integrated binding restrictions and/or moratoriums. In this regard, the data 208 includes, but is not limited to, raw government moratorium data 224 obtained by one or more of the government updating service(s) 210, raw underwriter moratorium data 226 obtained by one or more of the underwriter updating service(s) 212, user provided information 228 (e.g., a username, address, policy number, etc.), and standardized address information 230 obtained by the address normalization service 214. The data 208 further includes the disclosed moratorium database 232, one or more moratorium raw data parsing rules 234 used by the raw data parser 216, and moratorium evaluation results 236 determined by the evaluator 220 using the moratorium database 232 and the user provided information 228.

The government updating service(s) 210 and the underwriter updating service(s) 212 are each configured to retrieve binding restriction information and moratorium information from one or more of the government agency server(s) 108.112 and the insurance underwriter server(s) 110,114. As discussed above, the government updating service(s) 210 and/or the underwriter updating service(s) 212 may implement a push-based and/or pull-based model for ingesting binding restrictions and/or moratoriums issued by the government agency server(s) 108,110 and/or the insurance underwriter server(s) 110.114. For example, the government updating service(s) 210 may implement WebHooks and register a particular Uniform Resource Location (“URL”) with one or more of the government agency server(s) 108.110 and the underwriter updating service(s) 212 may implement a predetermined polling method using HTTP for determining whether updated binding restriction and/or moratorium information is available from one or more of the insurance underwriter server(s) 110,114.

Furthermore, the policy issuance architecture 104 may establish a one-to-one relationship between the updating service(s) 210-212 and the servers 108-114 with which the service(s) 210-212 communicate. In this fashion, each server 108-114 that provides binding restriction or moratorium information may be assigned a particular and/or unique service that ingests or receives the information that the server provides.

As the service(s) 210-212 receive the binding restriction and/or moratorium information from the various servers 108-114, the service(s) 210-212 may temporarily store the receiving information as the raw government moratorium data 224 and/or the raw underwriter moratorium data 226. Although FIG. 2 illustrates the raw government moratorium data as element 224 and the raw underwriter moratorium data as element 226, one of ordinary skill in the art will appreciate that element 224 may further include raw government binding restriction data and that element 226 may further include raw underwriter binding restriction data. The raw government moratorium data 224 and the raw underwriter moratorium data 226 are illustrated separately because each of the government agencies and/or insurance underwriters may issue binding restrictions and/or moratoriums in a particular file format and/or combination of file formats. Examples of file formats that the government updating service(s) 210 and/or underwriter updating service(s) 212 may obtain and/or retrieve from the various servers 108-114 include, but are not limited to, Microsoft® Word® (e.g., DOC and/or DOCX). Microsoft® Excel® (e.g., XLS and/or XLSX), Open Document Format for Office Applications (e.g., ODT. FODT, ODS, and/or FODS), a comma-separated values file (.CSV), a plain text file (TXT). Multipurpose Internet Mail Extension (MIME), and other such file formats now known and/or later developed.

One of the challenges in working with many different agencies and/or underwriters is that each of the agencies and/or underwriters may use a particular file format for updating information about binding restrictions and/or moratoriums. Accordingly, the policy issuance architecture 104 may implement a raw data parser 216 configured to translate and/or parse the data received from the various servers 108-114 from an original format to a target format. In one embodiment, the policy issuance architecture 104 implements the moratorium database 232 as a text file, discussed below, in which case, the raw data parser 216 is configured to translate the raw government moratorium data 224 and/or the raw underwriter moratorium data 226 from their original format to a plain text format (e.g., a TXT file or the like). Additionally and/or alternatively, where the binding restriction and/or moratorium data is already in a plain text compatible format (e.g., a CSV file), the raw data parser 216 may parse the plain text compatible format so as to obtain values usable by the moratorium database updater 218 to update the moratorium database 232.

To parse and/or translate the raw government moratorium data 224 and/or the raw underwriter moratorium data 226, the raw data parser 216 may reference and/or invoke one or more moratorium raw data parsing rules 234. In one embodiment, the moratorium raw data parsing rules 234 further include one or more translators to translate the original file format of the received binding restriction data and/or moratorium data to the target format used by the policy issuance architecture 104, such as a plain text format. In some instances, a direct translation may not be possible (e.g., from an XLSX file to a TXT file) and the raw data parser 216 may invoke one or more intermediary translators to further translate the binding restriction and/or moratorium data. These translations may be considered a transitional step prior to updating the moratorium database 232 with the received and/or obtained raw government moratorium data 224 and/or the raw underwriter moratorium data 226.

After these one or more translations, the moratorium raw data parsing rules 234 may then instruct the raw data parser 216 as to how one or more values and/or attributes of the translated data map to the attributes of the moratorium database 232. The mapping of the raw government moratorium data 224 and/or the raw underwriter moratorium data 226 is a technical benefit to the policy issuance architecture 104 because the government agency and/or insurance underwriter may not use the same labels and/or attributes as used by the policy issuance architecture 104. For example, the policy issuance architecture 104 may use an attribute of “zip” to identify one or more ZIP codes affected by a binding restriction and/or moratorium, whereas the government agency and/or insurance underwriter may use an attribute of “geography” to refer to the same values. Thus, the moratorium raw data parsing rules 234 may include one or more rule sets unique and/or specific to a corresponding government agency and/or insurance underwriter to account for the differences in which the values of the binding restriction data and/or moratorium data is labelled.

By way of example, where the policy issuance architecture 104 is in communication with three government agency servers and two insurance underwriter servers, where each government agency and/or insurance underwriters label their binding restriction data values and/or moratorium data values differently, the moratorium raw data parsing rules 234 may include five sets of rules (each set having one or more rules) for accurately mapping the values provided by the government agencies and/or insurance underwriters to the attributes used by the policy issuance architecture 104. In this manner, the moratorium raw data parsing rules 234 provide a technical benefit to the policy issuance architecture 104 in that they allow the policy issuance architecture 104 to accurately ingest and integrate the binding restriction and/or moratorium data values provided by the government agencies and/or insurance underwriters.

Once mapped, the moratorium database updater 218 updates the moratorium database 232 with the information from the mapped raw government moratorium data 224 and from the mapped raw underwriter moratorium data 226. As explained above, updating the moratorium database 232 includes, but is not limited to, creating new entries, modifying existing entries, or removing existing entries. Each entry in the moratorium database 232 includes a variety of database attributes, as shown in Table 1, below.

TABLE 1

| Database | |
|---|---|
| Attribute | Description |
| id | Unique identifier for the binding restriction or |
| | moratorium |
| zip | Identifies the ZIP codes to which the binding |
| | restriction or moratorium applies. |
| type | Identifies the natural disaster or condition that caused |
| | the binding restriction or moratorium to be issued. |
| county | Identifies the counties covered by the binding |
| | restriction and/or moratorium. |
| fromDate | Identifies the date on which the binding restriction |
| | and/or moratorium starts. The binding restriction or |
| | moratorium may be added to the moratorium |
| | database 232 prior to the date identified by fromDate. |
| toDate | Identifies the date on which the binding restriction |
| | and/or moratorium ends. The expiration of this date |
| | may result in the binding restriction and/or |
| | moratorium being automatically removed by the |
| | moratorium database updater 218. |
| product | Identifies the insurance policies and/or products to |
| | which the binding restriction and/or moratorium |
| | applies. Example values include “ho3” to identify |
| | standalone dwellings and “ho6” to identify |
| | condominiums or other multiunit dwellings. |
| disabled | Identifies whether the binding restriction and/or |
| | moratorium is disabled. |
| created_at | Identifies the date on which the binding restriction |
| | and/or moratorium was created. This attribute may |
| | correspond to the date on which the binding |
| | restriction and/or moratorium was created by the |
| | issuing government agency and/or insurance |
| | underwriter. Alternatively, this attribute may |
| | correspond to the date on which the binding |
| | restriction or moratorium was added to the |
| | moratorium database 232 |
| created_by | Identifies the application and/or service that added |
| | the entry to the moratorium database 232. |
| updated_at | Identifies a date and/or time when the current entry |
| | was updated (if applicable). |

Each of the foregoing attributes of Table 1 may correspond to a single binding restriction or moratorium added to the moratorium database 232. Some of the attributes, such as “zip” or “county” may have multiple values (e.g., more than seven or eight) and, if a traditional relational database was implemented (e.g., a SQL 1:1 database and/or a database that uses a 1:many tables structure), each value would correspond to a single cell (e.g., an intersection of a row and column) within the database. Thus, a traditional database would quickly grow in the individual number of cells, which has a multitude of adverse effects on the database, such as reduced search time and an increased probability in database fragmentation and/or database inconsistency.

To address these challenges, and in one embodiment, the policy issuance architecture 104 implements the moratorium database 232 as a single text-based file using a data interchange format, such as JavaScript Object Notation (“JSON”). Additionally, and/or alternatively, the policy issuance architecture 104 may implement the moratorium database 232 using another structured language, such as Extensible Markup Language (“XML”) or Standard Generalized Markup Language (“SGML”).

By using a data interchange format to structure the disclosed moratorium database 232, the policy issuance architecture 104 can obtain database results from the moratorium database 232 much quicker than using a traditional, relational database. Furthermore, by using a data interchange format that has an implicit structure and arrangement, one or more components of the policy issuance architecture 104 can query and/or operate on the moratorium database 232 using syntax and programming language similar to the syntaxes used in database query languages, such as Structured Query Language (“SQL”). In one embodiment, the disclosed moratorium 232 implements JSONB columns to store the various binding restrictions and/or moratoriums.

To illustrate the arrangement of the entries within the moratorium database 232, below is an example of some entries that may appear in the moratorium database 232:

{

“ca”: {
“binding restrictions”: [

{
“id”: 1,
“zip”: “95020, 96067, 96025, 93238, 93285, 96048, 96109,
91201, 91207, 91208, 91214, 91042, 91352, 91501, 93643,
95423, 92223”,
“type”: “brush_fire”,
“county”: “Siskiyou, Mariposa, Lassen”,
“toDate”: “09/10/2017”,
“product”: “ho3, ho6”,
“disabled”: true,
“fromDate”: “09/06/2017”,
“created_at”: “2017-09-06T18:43:45.175Z”,
“created_by”: “google-oauth2|104308871527464034325”,
“updated_at”: “2017-09-07T23:01:44.376Z”
}
{
“id”: 2,
“zip”: “95210, 95211, 95212, 95213, 95237, 95240, 95220,
95336, 95337, 95366, 95307, 95326, 95358, 95361, 95357,
95380, 95315, 95324”,
“type”: “brush_fire”,
“county”: “Stockton, Modesto”,
“city”: “Morada, Lockeford, Manteca, Ceres, Oakdale,
Turlock”
“toDate”: “09/10/2017”,
“product”: “ho3, ho6”,
“disabled”: false,
“fromDate”: “09/06/2017”,
“created_at”: “2017-09-06T18:43:45.175Z”,
“created_by”: “google-oauth2|104308871527464034325”,
“updated_at”: “2017-09-07T23:01:44.376Z”
}

]

```
  }
  “il”: {
```

“moratoriums”: [

{
“id”: 1,
“zip”: “60078, 60070, 60094, 60130, 60133, 60208, 60411,
60611”,
“type”: “blizzard”,
“county”: “Cook”,
“toDate”: “2/10/2018”,
“product”: “ho3, ho6”,
“disabled”: true,
“fromDate”: “01/02/2018”,
“created_at”: “2018-02-01T18:43:45.175Z”,
“created_by”: “google-oauth2|104308871527464034325”,
“updated_at”: “2017-09-07T23:01:44.376Z”

}

]

}

}

In the foregoing example, the moratorium database 232 includes two entries, one entry associated with California and one entry associated with Illinois. With regard to the California entry, this entry corresponds to a binding restriction and indicates that there are binding restrictions in place for the counties of Siskiyou, Mariposa. and Lassen due to a brush fire. Although one binding restriction entry is shown, the moratorium database 232 is configured to support hundreds or thousands of other such entries.

With regard to the Illinois entry, this entry corresponds to a moratorium and indicates that there is a moratorium on cancelling insurance policies issued in Cook County due to a blizzard. Although one moratorium entry is shown, the moratorium database 232 is configured to support hundreds or thousands of other such entries.

In the foregoing example, the moratorium database 232 has been configured to support multiple states. Accordingly, in this example, the moratorium database 232 comprises a single file, where the single file includes entries for each of the states managed by the policy issuance architecture 104. Additionally and/or alternatively, policy issuance architecture 104 may implement the moratorium database 232 across multiple files, where each file corresponds to a particular state. Thus, in this embodiment, there is a file that corresponds to California, a file that corresponds to Illinois, a file that corresponds to Arizona, and so forth. By splitting up the moratorium database 232 into multiple files, where each file represents a corresponding state, the policy issuance architecture 104 can further reduce the amount of time it would take to search and/or update the moratorium database 232 because the policy issuance architecture 104 needs only to search the file that corresponds to a particular state, and then update the file accordingly. Where the policy issuance architecture 104 uses multiple files, the policy issuance architecture 104 may maintain a mapping of filenames (or other attribute to uniquely identify a file) and the states the files represent.

The evaluator 220 is configured to evaluate whether one or more of the binding restrictions and/or moratoriums stored in the moratorium database 232 apply to a given customer. In one embodiment, the evaluator 220 performs this evaluation by comparing the attribute values of user provided information 228 with one or more of the attribute values retrieved from the moratorium database 232. The attributes of the user provided information 228 include such as attributes as street address, city of residence, county of residence, first name, last name, and ZIP code.

In evaluating the user provided information 228, the policy issuance architecture 104 may first normalize the user provided information 228 via the address normalization service 214. The policy issuance architecture 104 is configured to obtain a normalized address from the user provided information 228 because, in certain instances, the user provided information 228 may be incorrect or lacking one or more attribute values. In this regard, the address normalization service 214 may communicate one or more of the attribute values from the user provided information 228 to the address normalization service 106. Normalization, in this context, is the process of providing an address that may be more complete and/or more accurate than what a customer (e.g., a user of one or more of the client devices 116-120). Examples of the address normalization service 106 include, but are not limited to, SmartyStreets, the United States Postal Service. Melissa Data. and Loqate. Each of these address normalization services 106 may provide an API that the policy issuance architecture 104 may leverage in standardizing and/or normalizing addresses from the user provided information 228. The address normalization service 214 may then store the normalized and/or standardized address as the standardized address information 230.

The evaluator 220 then evaluates the standardized address information 230 using one or more attribute values of the standardized address information to query with the moratorium database 232. To evaluate the standardized address information 230, the evaluator 220 may query the moratorium database 232 with particular attribute values selected from the standardized address information 230, such as the ZIP code attribute value and/or the county attribute value. A non-zero or non-NULL return from the moratorium database 232 may then indicate whether a binding restriction or moratorium would apply to the customer or policyholder associated with the standardized address information 230. The return value, whether NULL or not, returned from the moratorium database 232 may be stored as the moratorium evaluation results 236.

Where the return value is not NULL or non-zero, the evaluator 220 determines that a binding restriction or moratorium does not apply to the customer or policyholder associated with the standardized address information 230. In contrast, where the return value is not NULL or non-zero, the evaluator 220 may determine that a binding restriction and/or moratorium does apply to the customer or policyholder associated with the standardized address information 230. Where a binding restriction and/or moratorium does apply, the moratorium evaluation results 236 may include one or more attribute values from the moratorium database 232 including, but not limited to, whether a “binding restriction” or “moratorium” applies, the reason for the binding restriction and/or moratorium (e.g., the value from the “type” attribute), the starting date of the binding restriction and/or moratorium, and/or the ending date of the binding restriction and/or moratorium.

As the values, in of themselves, may be unhelpful to the customer and/or policyholder, the evaluator 220 is configured to display a user-friendly value and/or message corresponding to one or more values from the moratorium database 232. In one embodiment, the evaluator 220 performs an operation on the attribute value from the moratorium database 232 based on the attribute associated with the attribute value. For example, with regard to the “type” attribute, the evaluator 220 may replace the value of “blizzard” with the value of “Heavy Snows.” As another example, the evaluator 220 may calculate a duration of time that the binding restriction and/or moratorium applies using the retrieved start date and the retrieved end date associated with the binding restriction and/or moratorium. Using these transformations, the evaluator 220 may be configured to generate a user-friendly message or graphical user interface that is then displayed to the customer and/or policyholder. Additionally, and/or alternatively, the evaluator 220 may simply generate a message that indicates whether the policy issuance architecture 104 can issue a policy of the customer and/or policyholder without providing the specific details relating to the binding restriction and/or moratorium (if applicable).

To facilitate interactions between the customer and/or policyholder with the policy issuance architecture 104, the policy issuance architecture 104 may implement a web service frontend 222 that communicates with one or more of the client devices 116-120 being executed by the one or more client devices 116-120. For example, where a client device 116 uses a web browser to access the policy issuance architecture 104, the web service frontend 222 provides one or more webpages to the web browser for display by the client device 116. Similarly, where the client device 116 uses an app to access the policy issuance architecture 104, the web service frontend 222 receives messages from the app and communicates messages in return to the app for display by the client device 116. In this way, the web service frontend 222 serves as a mechanism by which users of the one or more client devices 116-120 communicate and interact with the policy issuance architecture 104.

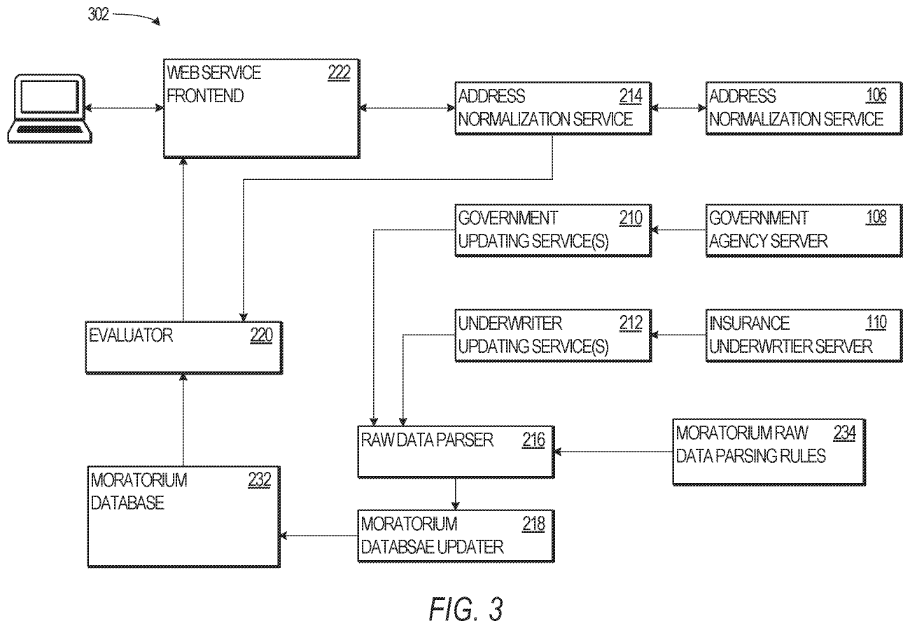

FIG. 3 illustrates a processing diagram 302, in accordance with an example embodiment, of the application(s)/module(s) 206 of the policy issuance architecture 104, shown in FIG. 2, for implementing the disclosed moratorium database 232 and evaluating standardized addresses derived from user provided information 228.

In one embodiment, the government updating service(s) 210 are communicatively coupled to the government agency server 108 and the underwriter updating service(s) are communicatively coupled to the insurance underwriter server 110. In this context, being communicatively coupled implies that there may be one or more communication channels, both wired and wireless, between the government updating service(s) 210 and the government agency server 108, and between the underwriter updating service(s) 212 and the insurance underwriter server 110.

As explained above, the government agency server 108 and/or the insurance underwriter server 110 may implement a pull-based or push-based model for providing binding restriction and/or moratorium updates to their respective updating service(s) 210.212. Regardless of the specific information distribution model, each of the updating service(s) 210,212 are in communication with the raw data parser 216, which then processes the binding restriction and/or moratorium updates as the updating service(s) 210,212 obtains them. In one embodiment, the raw data parser 216 executes one or more moratorium raw data parsing rules 234 to extract relevant binding restriction and/or moratorium data values from the update information provided by the government agency server 108 and/or the insurance underwriter server 110. The moratorium raw data parsing rules 234 may include one or more translation rules (e.g., for translating between various document types), one or more mapping rules (e.g., for mapping attributes from the provided binding restriction and/or moratorium data to the attributes of the moratorium database 232), one or more data parsing rules (e.g., one or more regular expressions and/or matching rules to extract the data values from the provided binding restriction data and/or moratorium data), and other such data parsing rules or combinations thereof.

The values and/or updates obtained by the raw data parser 216 are then passed to the moratorium database updater 218. In one embodiment, the moratorium database updater 218 updates the moratorium database 232 using one or more SQL queries using the values and/or updates obtained by the raw data parser 216. As explained with reference to FIG. 2, the moratorium database 232 may be instantiated as a JSON file written as a plain text file that defines the binding restrictions and/or moratoriums within one or more arrays or as one or more array-like data structures. By using a JSON file as a database, the disclosed policy issuance architecture 104 can quickly search and update the moratorium database 232 than if the moratorium database 232 was implemented as a traditional, relational database (e.g., a two-dimensional database conforming to a MySQL. PostgreSQL, or other SQL-like data format). In one embodiment, the operations performed on the moratorium database 232 are faster because the moratorium database 232 is implemented as JSONB columns rather than as a traditional database table that uses key/value pairs. As discussed above, updates to the moratorium database 232 may include, but are not limited to, additions, deletions, insertions, or individual attribute value updates.

As shown in FIG. 3, the web service frontend 222 is communicatively coupled with the client device and is in communication with the evaluator 220. In one embodiment, the web service frontend 222 provides one or more webpages to the client device that the user (e.g., policyholder) can interact with to provide user information including, but not limited to, a policy number, address, biographical information (e.g., first name, last name, age, date of birth, etc.), and other such information. The web service frontend 222 may then communicate with an internal address normalization service 214 that calls an API provided by an external address normalization service 106. As explained above, the web service frontend 222 may invoke the internal address normalization service 214 with a user-provided address and request that the internal address normalization service 214 return a standardized (or normalized) address. In one embodiment, the internal address normalization service 214 communicates with the external normalization service 106 to obtain a standardized (or normalized) address from the user-provided address.

The internal address normalization service 214 may then pass the standardized address (e.g., standardized address information 230) to the evaluator 220 to evaluate the standardized address against the one or more binding restrictions and/or moratorium stored in the moratorium database 232. In one embodiment, the evaluator 220 evaluates multiple fields and/or attributes of the stored binding restrictions and/or moratoriums, such as the ZIP code values, the county values, the starting date and ending date values, or any combination of these attribute values.

Where the evaluator 220 determines that one or more binding restrictions and/or moratoriums apply given the standardized address information (e.g., binding restriction and/or moratorium is in effect and covers a county and/or ZIP code associated with the standardized address information), the evaluator 220 may instruct the web service frontend 222 to display a web page or other prompt informing the user of the results of the evaluation. In one example, where the user is a potential customer requesting a new policy, the web service frontend 222 may display a webpage or prompt informing the user that a requested policy cannot be issued or that a requested policy is limited in some way. In another example, where the user is an insurance agent and is attempting to cancel a policy associated with a customer, the web service frontend 222 may display a webpage or prompt informing the user that the policy cannot be cancelled.

Conversely, where the evaluator 220 determines that one or more binding restrictions and/or moratoriums do not apply given the standardized address information (e.g., the ZIP code and/or county associated with the standardized address information does not match any of the ZIP codes and/or counties of a binding restriction and/or moratorium in effect), the evaluator 220 may return a value indicating that the web service frontend 222 is to continue with the action requested by the user. For example, where the user is a customer and is requesting a new policy to be issued, the web service frontend 222 may proceed with the issuance of the policy. As another example, where the user is an insurance agent is requesting cancellation of a policy, the web service frontend 222 may proceed with the cancellation of the policy. In this manner, the results of the evaluator 220 inform the web service frontend 222 as to how it should proceed.

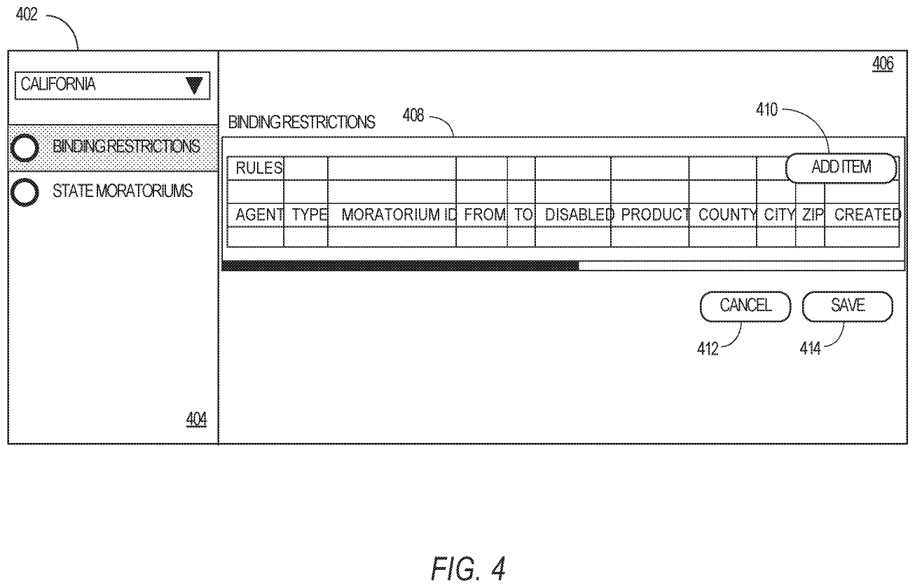

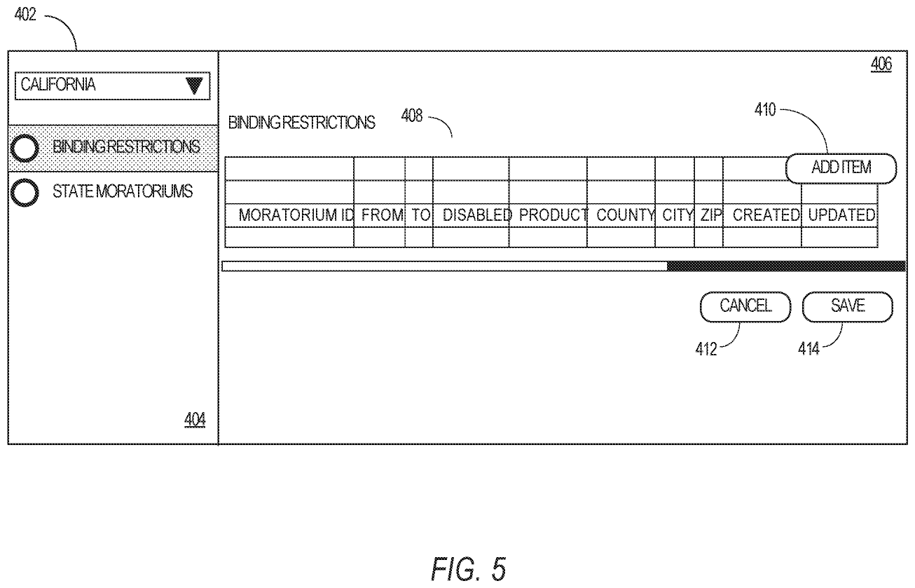

FIGS. 4-5 illustrate a graphical user interface 402, according to example embodiments, for manipulating one or more binding restrictions and/or moratoriums maintained by the policy issuance architecture 104. The graphical user interface 402 may be instantiated in various environments including, but not limited to, a web page, an app, a programmatic application, or any other known software environment or combinations thereof.

In one embodiment, the graphical user interface 402 includes two sections 404-406 for editing the binding restrictions and/or moratoriums of the moratorium database 234. Although illustrated as the two sections 404-406, the graphical user interface 402 may include alternative, additional, or fewer sections for representing the binding restrictions and/or moratoriums stored in the moratorium database 234.

In one embodiment, the first section 404 includes a geographic selection element that allows the user (e.g., an administrator or other authorized user of the insurance policy architecture 104) to select the state (or other geographic entity) in which a binding restriction and/or moratorium is implemented or will be implemented. Although shown as a drop-down menu in FIGS. 4-5, the geographic selection element may be implemented as other selection elements, such as radio buttons, selectable buttons, or other selection elements.

The first section 404 further includes a type selection element that allows the user to the binding restrictions and/or moratoriums for a geographic region selected in the geographic selection element. As shown in FIGS. 4-5, the user may select binding restrictions or state moratoriums based on the geographic region previously selected. In one embodiment, the web service frontend populates the second section 406 with the attribute values of the selected binding restrictions or moratoriums by searching the moratorium database 232 for a particular type of identifier, such as “binding restriction” or “moratorium.” and then looping through each of the array elements of the array having the “binding restriction” or “moratorium” identifier. The values for each of the attributes of a particular binding restriction or moratorium are then populated into the second section 406 of the graphical user interface 402.

Accordingly, in one embodiment, the second section 406 includes an editing section 408 for displaying and/or editing selected binding restrictions or moratoriums, and one or more graphical elements 410-414 for manipulating the binding restrictions and/or moratoriums displayed in the editing section 408. In one embodiment, the user of the graphical use interface 402 may select individual attributes displayed in the editing section 408 and add, change, and/or remove their corresponding values. To this end, the graphical elements 410-414 include an “add item” element 410 that, when selected, adds a new binding restriction and/or moratorium to the moratorium database 234; a “cancel” element 412 that, when selected, cancels any pending operations (e.g., adding a binding restriction or moratorium, editing attribute values, etc.); and a “save” element 414 that, when selected, commits any changes made in the editing section 408 to the moratorium database 234. In this way, the graphical user interface 402 is an editor that allows a user to manually manage the entries and/or values stored in the moratorium database 234. The graphical user interface 402 is technically beneficially to the policy issuance platform 104, as a whole, because it allows a user to manage a process that is automated within the policy issuance platform 104 and allows the user to manage the complexity of the moratorium database 234 without having to understand the underlying architecture or schema of that database 234.

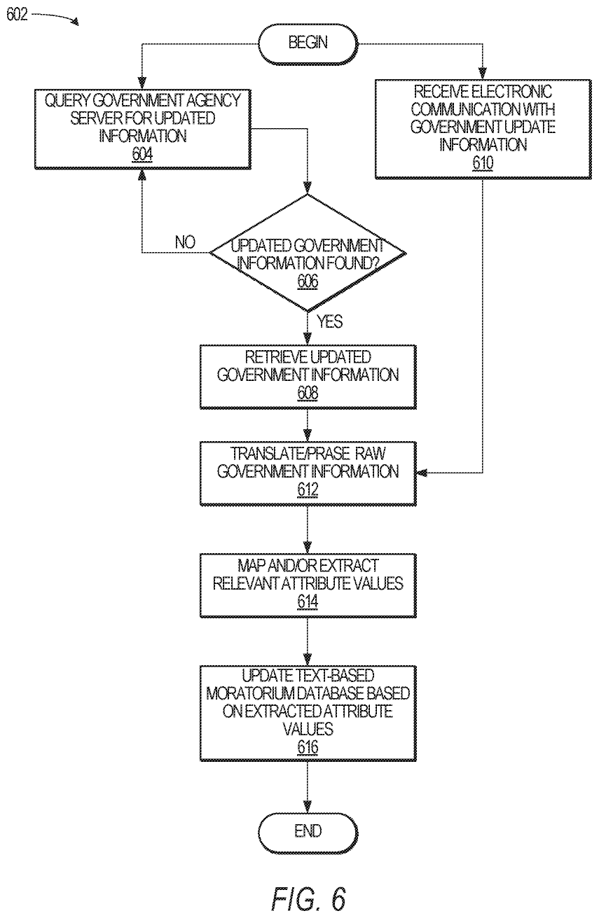

FIG. 6 illustrates a method 602, in accordance with an example embodiment, for obtaining binding restriction and/or moratorium data from a government agency server as shown in FIG. 1. The method 602 may be implemented by one or more of the components illustrated in FIG. 2 and is discussed by way of reference thereto.

FIG. 6 illustrates that the method 602 may be implemented whether a government agency server (e.g., government agency server 108 or government agency server 112) implements a pull-based or push-based information distribution model. Where the government agency server implements a pull-based information distribution model, one or more of the government updating service(s) 210 may query the government agency server for updating information on one or more binding restrictions and/or moratoriums (Operation 604). As explained previously, under a pull-based model the government updating service(s) 210 may be configured to periodically poll the government agency server on a predetermined schedule (e.g., once an hour, once a day, etc.). The government updating service(s) 210 then determines whether the government agency server has any additional or updated information relating to one or more binding restrictions and/or moratoriums (Operation 606).

Where the determination of Operation 606 is made in the negative (e.g., the “NO” branch of Operation 606), the government updating service(s) 210 return to their predetermined polling schedules (e.g., Operation 604). Alternatively, where the determination of Operation 606 is made in the affirmative (e.g., the “YES” branch of Operation 606), the government updating service(s) 210 retrieve the updated binding restriction and/or moratorium information (Operation 608). As discussed with reference to FIG. 2, this information may be stored as the raw government moratorium data 224.

Additionally, and/or alternatively, the government agency server may implement a push-based information distribution model, where a user or administrator of the policy issuance architecture 104 registers one or more of the government updating service(s) 210 to receive binding restriction and/or moratorium updates from the government agency server. As explained above, the policy issuance architecture 104 and/or the government agency server may implement WebHooks as one method of obtaining or distributing the binding restriction and/or moratorium information. Accordingly, under this information distribution model, the government updating service(s) 210 may receive updated binding restriction and/or moratorium information when such information is published by the government agency server (Operation 610).

The binding restriction and/or moratorium information, whether distributed under a pull-based or push-based model is then provided as input to the raw data parser 216 (Operation 612). As explained with reference to FIG. 2, the government agency may provide the binding restriction and/or moratorium information in a data format particular to the government agency, and the raw data parser 216 is configured to translate and/or parse relevant binding restriction or moratorium attribute values from the provided information. Accordingly, in one embodiment, the raw data parser 216 executes one or more moratorium raw data parsing rules 234 to translate and/or parse the government update information. The moratorium raw data parser 216 may then map and/or extract the attribute values from the translated and/or parsed government information and assign such attribute values to the binding restriction attributes and/or moratorium attributes maintained by the policy issuance architecture 104 (Operation 614).

The moratorium database updater 218 may then update the moratorium database 232 according to the values obtained from the government information (Operation 616). As discussed with reference to FIG. 2, updating the moratorium database 232 may include adding one or more binding restrictions and/or moratoriums, removing one or more binding restrictions and/or moratoriums, adding or removing values from the moratorium database 232, and other such modifications to the moratorium database 232. As the moratorium database 232 may be implemented as a text file that is logically ordered according to a data interchange format, like JSON, or other structured markup language, like XML, the updates to the moratorium database 232 are applied in real-time or near real-time as the updates are received from the government agency server. As explained previously, one technical benefit from this particular implementation is that updates from the government agency server are ready for deployment and/or application substantially close in time as to the time such updates were issued by the government agency.

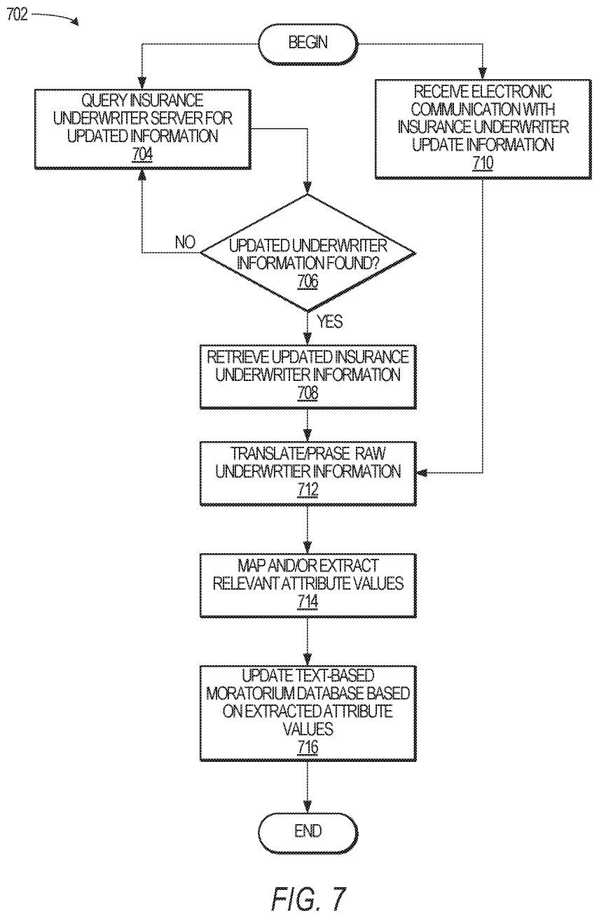

FIG. 7 illustrates a method 702, in accordance with an example embodiment, for obtaining binding restriction and/or moratorium data from an insurance underwriter server as shown in FIG. 1. The method 702 may be implemented by one or more of the components illustrated in FIG. 2 and is discussed by way of reference thereto.

FIG. 7 illustrates that the method 702 may be implemented whether an insurance underwriter server (e.g., insurance underwriter server 110 or insurance underwriter server 114) implements a pull-based or push-based information distribution model. Where the insurance underwriter server implements a pull-based information distribution model, one or more of the underwriter updating service(s) 212 may query the insurance underwriter server for updating information on one or more binding restrictions and/or moratoriums (Operation 704). As explained previously, under a pull-based model, the underwriter updating service(s) 212 may be configured to periodically poll the insurance underwriter server on a predetermined schedule (e.g., once an hour, once a day, etc.). The underwriter updating service(s) 212 then determines whether the insurance underwriter server has any additional or updated information relating to one or more binding restrictions and/or moratoriums (Operation 706).

Where the determination of Operation 706 is made in the negative (e.g., the “NO” branch of Operation 706), the underwriter updating service(s) 212 return to their predetermined polling schedules (e.g., Operation 704). Alternatively, where the determination of Operation 706 is made in the affirmative (e.g., the “YES” branch of Operation 706), the underwriter updating service(s) 212 retrieve the updated binding restriction and/or moratorium information (Operation 708). As discussed with reference to FIG. 2, this information may be stored as the raw underwriter moratorium data 226.

Additionally, and/or alternatively, the insurance underwriter server may implement a push-based information distribution model, where a user or administrator of the policy issuance architecture 104 registers one or more of the underwriter updating service(s) 212 to receive binding restriction and/or moratorium updates from the insurance underwriter server. As explained above, the policy issuance architecture 104 and/or the insurance underwriter server may implement WebHooks as one method of obtaining or distributing the binding restriction and/or moratorium information. Accordingly, under this information distribution model, the underwriter updating service(s) 212 may receive updated binding restriction and/or moratorium information when such information is published by the insurance underwriter server (Operation 710).

The binding restriction and/or moratorium information, whether distributed under a pull-based or push-based model is then provided as input to the raw data parser 216 (Operation 712). As explained with reference to FIG. 2, the insurance underwriter may provide the binding restriction and/or moratorium information in a data format particular to the insurance underwriter, and the raw data parser 216 is configured to translate and/or parse relevant binding restriction or moratorium attribute values from the provided information. Accordingly, in one embodiment, the raw data parser 216 executes one or more moratorium raw data parsing rules 234 to translate and/or parse the underwriter update information. The moratorium raw data parser 216 may then map and/or extract the attribute values from the translated and/or parsed government information and assign such attribute values to the binding restriction attributes and/or moratorium attributes maintained by the policy issuance architecture 104 (Operation 714).

The moratorium database updater 218 may then update the moratorium database 232 according to the values obtained from the underwriter information (Operation 716). As discussed with reference to FIG. 2, updating the moratorium database 232 may include adding one or more binding restrictions and/or moratoriums, removing one or more binding restrictions and/or moratoriums, adding or removing values from the moratorium database 232, and other such modifications to the moratorium database 232. As the moratorium database 232 may be implemented as a text file that is logically ordered according to a data interchange format, like JSON, or other structured markup language, like XML, the updates to the moratorium database 232 are applied in real-time or near real-time as the updates are received from the insurance underwriter server. As explained previously, one technical benefit from this particular implementation is that updates from the insurance underwriter server are ready for deployment and/or application substantially close in time as to the time such updates were issued by the insurance underwriter.

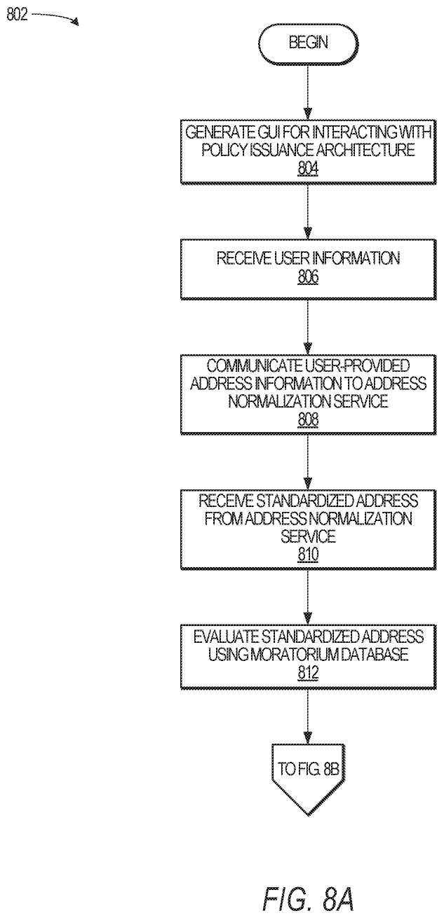

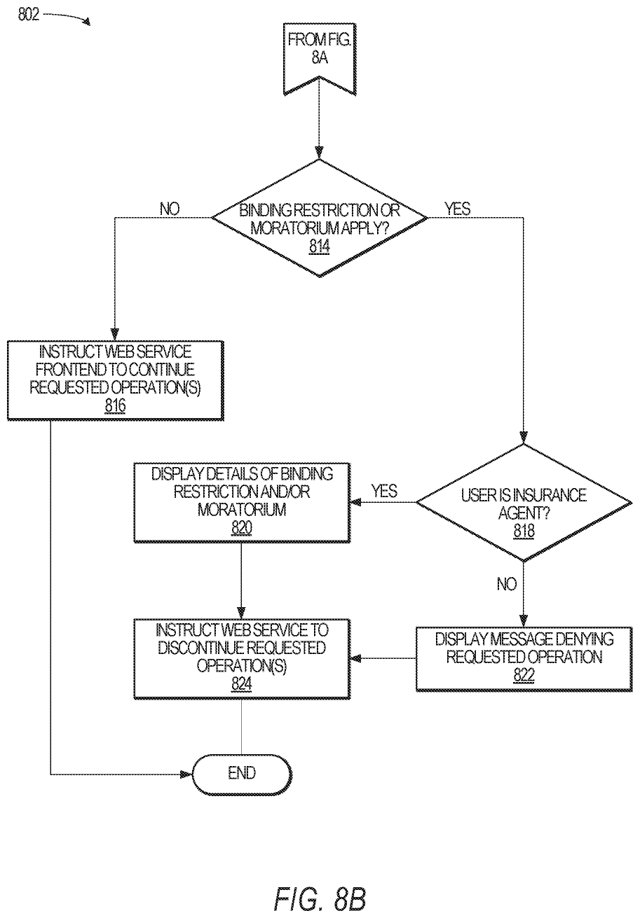

FIGS. 8A-8B illustrate method 802, in accordance with an example embodiment, for evaluating one or more binding restrictions and/or moratoriums using user-provided information. The method 802 is implemented by one or more components illustrated in FIG. 2 and is discussed by way of reference thereto.

Initially, and with reference to FIG. 8A, the web service frontend 222 generates one or more graphical user interfaces for display to a user of the policy issuance architecture 104 (Operation 804). As explained above, the one or more graphical user interfaces may include one or more webpages, one or more display screens displayed by an app being executed by a client device, one or more display screens displayed by a programmatic client being executed by the client device, or combinations thereof.

During the course of interacting with the web service frontend 222, the user may be prompted to provide user-specific information, such as a username, password, service address, home address, and other such information. Accordingly, the web service frontend 222 receives this information from the user (Operation 806). As also explained with reference to FIG. 2, the user-provided information may be stored as the user provided information 228

The web service frontend 222 may then communicate one or more portions of the user-provided information, such as an address, to an internal address normalization service 214, which may then call an external address normalization service 106 (Operation 808). In some instances, an address may not be normalized, such as where the address is being retrieved from a user or customer database and/or where the address has been previously normalized. As a response from the external address normalization service 106, the internal address normalization service 214 may receive a standardized (or normalized) address (Operation 810). Accordingly, this information is stored as the standardized address information 230.

The evaluator 220 may then evaluate the standardized address information 230 using the moratorium database 232 to determine whether one or more binding restrictions and/or moratoriums apply to the standardized address (Operation 812). Referring to FIG. 8B, the evaluation of the standardized address information 230 may include determining whether one or more attribute values of the binding restrictions and/or moratoriums of the moratorium database 232 apply to the standardized address for one or more calendar date(s) (Operation 814). The evaluator 220 may compare such attribute values as the ZIP code values, the county values, the starting date values, the ending date values, or any other such attribute values stored by the moratorium database 232. In one embodiment, the queries to the moratorium database 232 are SQL queries.

Where the evaluator 220 determines that the binding restrictions and/or moratoriums stored in the moratorium database 234 do not apply (e.g., the “NO” branch of Operation 814), the method 802 proceeds to Operation 816. At Operation 816, the evaluator 220 may instruct the web service frontend 222 to continue one or more operations requested by the user, such as providing an insurance quote, cancelling a policy, binding an insurance policy, or any other such requested operation.

Alternatively, where the evaluator 220 determines that one or more binding restrictions and/or moratoriums do apply (e.g., the “YES” branch of Operation 814), the evaluator 220 may then determine whether the user is an insurance agent or another type of user (e.g., an existing policyholder or potential customer) (Operation 818). In one embodiment, the evaluator 220 performs this determination so that the insurance agent can be provided with a detailed explanation of why the web service frontend 222 was unable to continue with the requested one or more operation(s). Accordingly, where the evaluator 220 resolves Operation 818 in the affirmative (e.g., the “YES” branch of Operation 818), the evaluator 2220 may then instruct the web service frontend 222 to provide various details about the binding restriction(s) and/or moratorium(s) that apply to the standardized address information 230 (Operation 820). Operation 820 may be helpful to an insurance agent in explaining to a potential customer and/or policyholder why a particular operation could not be completed given the standardized address information.

Alternatively, where the evaluator 220 resolves Operation 818 in the negative (e.g., the “NO” branch of Operation 818), the method 802 proceeds to Operation 822, where the web service frontend 222 displays a user-friendly error message (e.g., a webpage with an explanation) that explains that the requested operation (e.g., to issue a particular policy) could not be completed. This message may also include details about the binding restriction and/or moratorium, but presented in a way that is understandable to the potential customer and/or policyholder.

The method 802 then proceeds to Operation 824, where the evaluator instructs the web service frontend 222 to discontinue, or not allow, a particular requested operation to be performed (e.g., cancel a policy, issue a policy, provide a quote, etc.). In this way, the user is prevented from continuing the requested operation where the policy issuance architecture 104 determines that one or more binding restrictions and/or moratoriums apply to the user-provided address information 228 (e.g., vis-à-vis the standardized address information 230). The web service frontend 222 may then generate, or cause the display of, one or more graphical user interfaces (e.g., one or more webpage(s) or display screen(s)) instructing the user to engage in a different operation or to provide instructions as to the operation that the user would next like to perform.

In this manner, the disclosed policy issuance architecture 104 provides a rapid response system for a user to determine whether one or more binding restrictions and/or moratoriums apply to a given address. As explained with reference to FIG. 2, the policy issuance architecture 104 leverages a non-traditional type of moratorium database 232 to manage the various binding restrictions and/or moratoriums, where the policy issuance architecture 232 implements the moratorium database 232 using a data interchange format (e.g., JSON) rather than a traditional, relational database format (e.g., SQL). Because the moratorium database 232 is implemented using a data interchange format, updates to the moratorium database 232 can occur extremely quickly relative to other databases and can be effectively managed without an administrator having to need a deep understanding of traditional database structures or syntaxes. A further technical benefit of the disclosed implementation of the moratorium database 232 is that the moratorium database 232 can be managed using traditional SQL queries (or queries similar to SQL queries). As the moratorium database 232 may be implemented using a known data interchange format or extensible markup language that is compatible with traditional SQL queries, developers or database managers can quickly adopt and learn how to manage the moratorium database 232. Thus, the disclosed systems and methods have numerous technical benefits over traditional deployments of databases used in the issuance of insurance policies.

### Modules, Components, and Logic

Certain embodiments are described herein as including logic or a number of components, modules, or mechanisms. Modules may constitute either software modules (e.g., code embodied on a machine-readable medium or machine-readable storage device) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein. “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-8B are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Architecture and Machine-Readable Medium

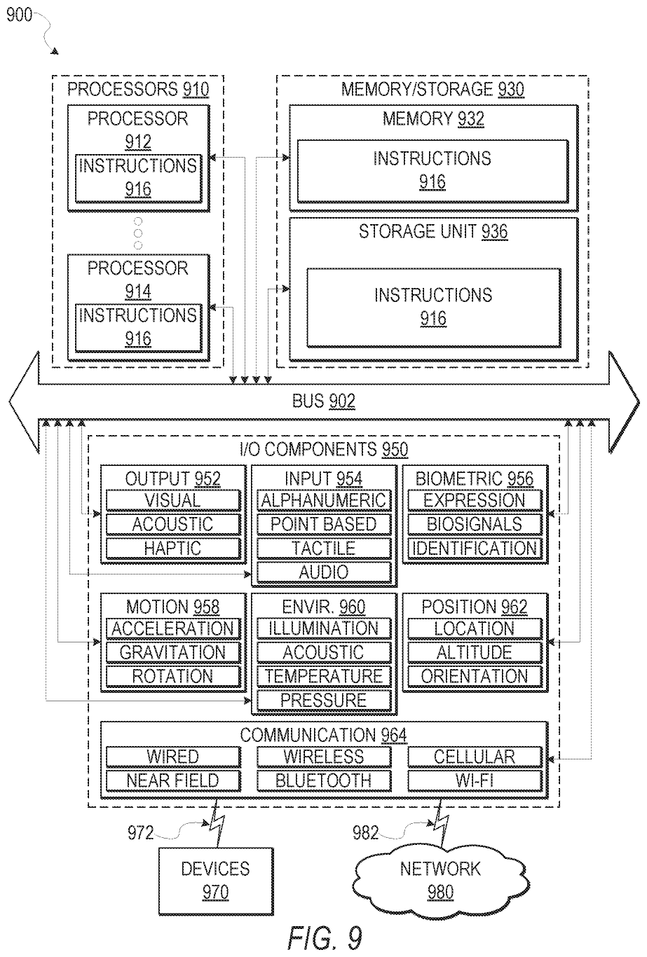

FIG. 9 is a block diagram illustrating components of a machine 900, according to some example embodiments, able to read instructions from a machine-readable medium (e.g., a machine-readable storage medium or machine-readable storage device) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the flow diagrams of FIGS. 6-8B. Additionally, or alternatively, the instructions 916 may implement one or more of the components of FIGS. 1-3. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a PDA, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory/storage 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, processor 912 and processor 914 that may execute the instructions 916. The term “processor” is intended to include multi-core processor that may comprise two or more independent processors (sometimes referred to as “cores”) that may execute instructions 916 contemporaneously. Although FIG. 9 shows multiple processors 910, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” includes a machine-readable storage device able to store instructions 916 and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972, respectively. For example, the communication components 964 may include a network interface component or other suitable device to interface with the network 980. In further examples, communication components 964 may include wired communication components, wireless communication components, cellular communication components, Near Field Communication (NFC) components. Bluetooth® components (e.g., Bluetooth® Low Energy). Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components. NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF416, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX). Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A system for implementing a multi-tiered database using a data interchange format, the system comprising:
a machine-readable medium storing computer-executable instructions; and
at least one hardware processor communicatively coupled to the machine-readable medium that, when the computer-executable instructions are executed, configures the system to:
receive a notification that updated information for an insurance moratorium is available from a first server that provides insurance moratorium information for the insurance moratorium;
update a database with the insurance moratorium information, wherein the database is implemented using a data interchange programming language;
receive address information corresponding to a user;
provide the address information to a standardization service that standardizes the received address information;
compare the standardized address information with insurance moratorium information stored in the database; and
cause a display of a graphical user interface based on the comparison of the standardized address information with the insurance moratorium information.

2. The system of claim 1, wherein the insurance moratorium information comprises a first plurality of attribute values and the standardized address information comprises a second plurality of attribute values; and
the comparison of the standardized address information with the moratorium information comprises a comparison of a least one attribute value selected from the first plurality of attribute values with at least one attribute value selected from the second plurality of attribute values.

3. The system of claim 1, wherein the notification of the updated information is provided through a subscription to an update service provided by the first server.

4. The system of claim 1, wherein the notification of the updated information is obtained by periodically polling the first server at predetermined time intervals to determine whether the updated information is available.

5. The system of claim 1, wherein the database is implemented as a multi-dimensional array comprising a plurality of levels, and a first level of the multi-dimensional array corresponds to a geographic region.

6. The system of claim 1, wherein:
a second level of the multi-dimensional array defines whether a plurality of array elements corresponds to the insurance moratorium information; and
the second level of the multi-dimensional array is nested within the first level of the multi-dimensional array.

7. The system of claim 1, wherein:
the graphical user interface that is displayed depends on a user type that requested the comparison of the standardized address information with the insurance moratorium information.

8. A system for implementing a multi-tiered database using a data interchange format, the system comprising:
means for receiving a notification that updated information for an insurance moratorium is available from a first server that provides insurance moratorium information for the insurance moratorium;
means for updating a database with the insurance moratorium information, wherein the database is implemented using a data interchange programming language;
means for receiving address information corresponding to a user;
means for providing the address information to a standardization service that standardizes the received address information;
means for comparing the standardized address information with insurance moratorium information stored in the database; and
means for causing a presentation of a graphical user interface based on the comparison of the standardized address information with the insurance moratorium information.

9. The system of claim 8, wherein the insurance moratorium information comprises a first plurality of attribute values and the standardized address information comprises a second plurality of attribute values; and
the means for comparing the standardized address information with the moratorium information compares at least one attribute value selected from the first plurality of attribute values with at least one attribute value selected from the second plurality of attribute values.

10. The system of claim 8, wherein the notification of the updated information is provided through a subscription to an update service provided by the first server.

11. The system of claim 8, wherein the notification of the updated information is obtained by periodically polling the first server at predetermined time intervals to determine whether the updated information is available.

12. The system of claim 8, wherein the database is implemented as a multi-dimensional array comprising a plurality of levels, and a first level of the multi-dimensional array corresponds to a geographic region.

13. The system of claim 8, wherein:
a second level of the multi-dimensional array defines whether a plurality of array elements corresponds to the insurance moratorium information; and
the second level of the multi-dimensional array is nested within the first level of the multi-dimensional array.

14. The system of claim 8, wherein:
the means for causing the display of the graphical user interface user displays different graphical user interfaces depending on a user type that requested the comparison of the standardized address information with the insurance moratorium information.

15. A method for implementing a multi-tiered database using a data interchange format, the method comprising:
receiving, by at least one processor, a notification that updated information for an insurance moratorium is available from a first server that provides insurance moratorium information for the insurance moratorium;
updating, by the at least one processor, a database with the insurance moratorium information, wherein the database is implemented using a data interchange programming language;
receiving, by the at least one processor, address information corresponding to a user;
providing, by a communication interface communicatively coupled to the at least one processor, the address information to a standardization service that standardizes the received address information;
comparing, by the at least one processor, the standardized address information with insurance moratorium information stored in the database; and
causing, by the at least one processor, a display of a graphical user interface based on the comparison of the standardized address information with the insurance moratorium information.

16. The method of claim 15, wherein the insurance moratorium information comprises a first plurality of attribute values and the standardized address information comprises a second plurality of attribute values; and
comparing the standardized address information with the moratorium information comprises comparing at least one attribute value selected from the first plurality of attribute values with at least one attribute value selected from the second plurality of attribute values.

17. The method of claim 15, wherein the notification of the updated information is provided through a subscription to an update service provided by the first server.

18. The method of claim 15, wherein the notification of the updated information is obtained by periodically polling the first server at predetermined time intervals to determine whether the updated information is available.

19. The method of claim 15, wherein the database is implemented as a multi-dimensional array comprising a plurality of levels, and a first level of the multi-dimensional array corresponds to a geographic region.

20. The method of claim 15, wherein:
a second level of the multi-dimensional array defines whether a plurality of array elements corresponds to the insurance moratorium information; and
the second level of the multi-dimensional array is nested within the first level of the multi-dimensional array.
